(19) United States
(12) Patent Application Publication
(10) Pub. No.: US 2013/0171463 A1
(43) Pub. Date: Jul. 4, 2013

(54) LOAD BEARING MEMBER HAVING PROTECTIVE COATING AND METHOD THEREFOR

(71) Applicants: Xiaoyuan Chang, Ellington, CT (US); Hong Yang, Avon, CT (US)

(72) Inventors: Xiaoyuan Chang, Ellington, CT (US); Hong Yang, Avon, CT (US)

(73) Assignee: OTIS ELEVATOR COMPANY, Farmington, CT (US)

(21) Appl. No.: 13/816,906

(22) PCT Filed: Aug. 13, 2010
(86) PCT No.: PCT/US2010/045415

§ 371 Date: Feb. 13, 2013

(51) Int. Cl. B66B 7/06

(52) U.S. Cl. CPC B66B 7/06; B66B 7/062
USPC 428/549; 427/434.6; 427/427

(57) ABSTRACT

A load bearing member includes at least one elongated tension member having at least one wire and a protective coating on the elongated tension member. The protective coating includes a first corrosion inhibitor having an oxide-forming metal, a second corrosion inhibitor having a rare earth metal, and a third corrosion inhibitor having an organic material.

### BACKGROUND

Elevator systems are widely known and used. Typical arrangements include an elevator cab that moves between landings in a building, for example, to transport passengers or cargo between different building levels. A motorized elevator machine moves a rope or belt assembly, which typically supports the weight of the cab, and moves the cab through a hoistway.

The elevator machine includes a machine shaft that is selectively rotationally driven by a motor. The machine shaft typically supports a sheave that rotates with the machine shaft. The ropes or belts are tracked through the sheave such that the elevator machine rotates the sheave in one direction to lower the cab and rotates the sheave in an opposite direction to raise the cab.

The rope or belt typically includes one or more tension members to support the weight of the elevator cab. The tension members may be encapsulated in a polymer jacket. One type of tension member comprises steel strands within a polymer jacket. The jacket surrounds the tension members and provides traction between the rope or belt and the sheave.

In use, the movement of the rope or belt over the sheave may cause degradation of the polymer jacket or expose the tension members to the surrounding environment. The surrounding environment may include moisture or other chemicals that can corrode the tension members. Typically, the tension members are treated with a zinc coating to increase corrosion resistance. The zinc coating serves as a sacrificial anode to protect the underlying steel tension members. In especially corrosive environments, the zinc may completely corrode and expose the underlying steel tension members.

### SUMMARY

An exemplary load bearing member includes at least one elongated tension member having at least one wire and a protective coating on the elongated tension member. The protective coating includes a first corrosion inhibitor having an oxide-forming metal, a second corrosion inhibitor having a rare earth metal, and a third corrosion inhibitor having an organic material.

An exemplary method for treating a load bearing member having at least one wire includes treating the at least one elongated tension member with a corrosion inhibiter solution. The solution includes a first corrosion inhibiter, a second corrosion inhibiter, and a third corrosion inhibiter. The first corrosion inhibiter is selected from an oxide-forming metal salt and combinations thereof. The second corrosion inhibiter is selected from rare earth metal salts and combinations thereof, and the third corrosion inhibiter is selected from organic salts and combinations thereof. The treatment produces a protective coating on the at least one elongated tension member.

### BRIEF DESCRIPTION OF THE DRAWINGS

FIG. 1 illustrates selected portions of an example elevator system.

FIG. 2 illustrates selected portions of an example load bearing member.

FIG. 3A illustrates an example tension member having a plurality of wires that are arranged to form strands, which are arranged to form a cord wherein each wire is coated.

FIG. 3B illustrates an example tension member having a plurality of wires that are arranged to form strands wherein the strand is coated.

FIG. 3C illustrates an example coated tension member having a plurality of wires that are arranged to form strands, which are arranged to form a cord wherein the cord is coated.

FIG. 4 illustrates a cross-sectional view of one alternative of a tension member having a protective coating.

FIG. 5 illustrates a cross-sectional view of another alternative of a tension member having a protective coating and an additional zinc coating.

### DETAILED DESCRIPTION

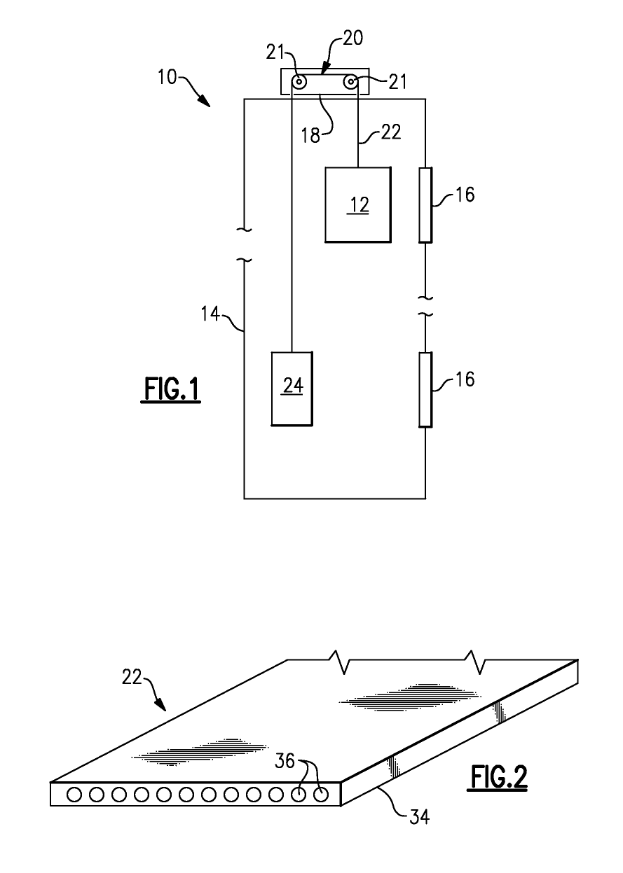

FIG. 1 schematically shows selected portions of an example elevator system 10 that includes an elevator cab 12 that moves in a hoistway 14 between landings 16 in a known manner. In the example shown, a platform 18 above the elevator cab 12 supports an elevator machine 20. The elevator machine 20 includes a sheave 21 for moving one or more load bearing members 22, such as an elevator rope or belt, to move the cab 12 and a counterweight 24 in a known manner up and down in the hoistway 14. The load bearing members 22 support the weight of the elevator cab 12 and counterweight 24. Of course, the elevator system 10 in FIG. 1 is exemplary, and the present invention could be used in elevator systems having other arrangements. For example, FIG. 1 shows a 1:1 roping arrangement with the ends of the load bearing members 22 secured to the cab 12 and counterweight 24. The present invention could equally be used in other roping arrangements, such as a 2:1 in which the ends of the load bearing members 22 are secured to fixed structures within the hoistway and the load bearing members 22 engage idler sheaves on the cab 12 and counterweight 24.

FIG. 2 shows selected portions of an example load bearing member 22 that includes a polymer jacket 34, such as polyurethane or another polymer, which at least partially surrounds a tension member 36. The illustration shows a plurality of tension members 36 but, as known, the load bearing member 22 may comprise any number of tension members 36 or even a single tension member 36. One example load bearing member 22 is a coated steel rope. Another example load bearing member 22 is a flat coated steel belt.

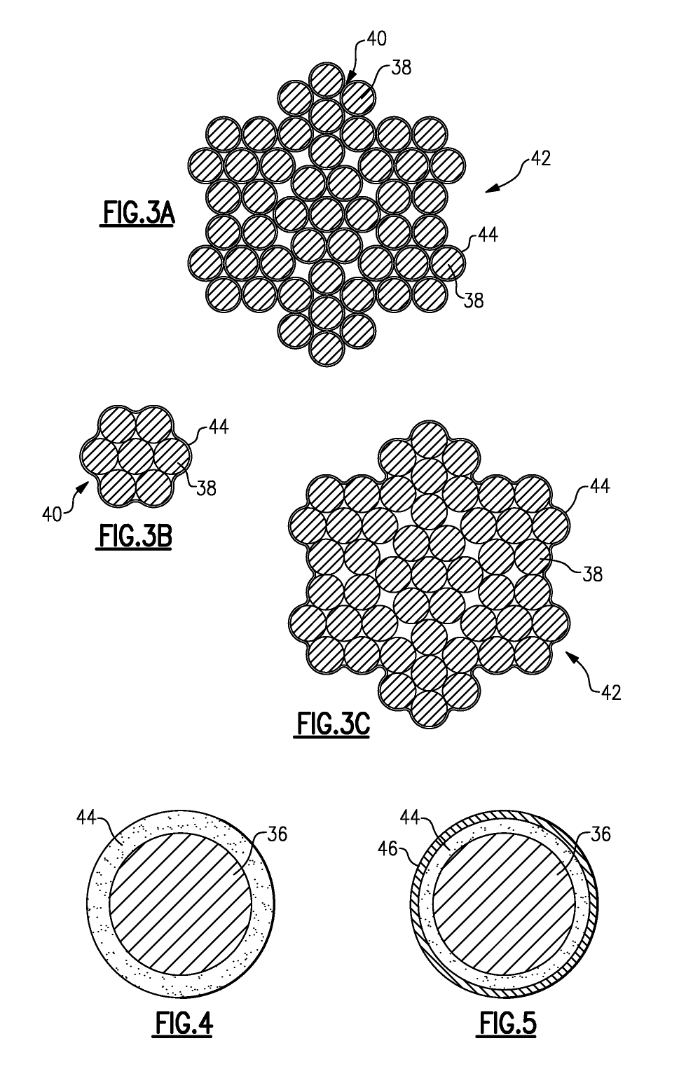

The tension member 36 is not limited to any particular kind and may include wires, strands, and cords. For instance, the tension member 36 may include one or more wires 38, such as steel wires. Alternatively, the tension member 36 may include a plurality of wires that are arranged (e.g., wound) to form a strand 40, as in FIG. 3B. In a further example, the tension member 36 may include one or more strands that are arranged (e.g., wound) with one or more wires as. In another option, the tension member 36 may include a plurality of strands arranged (e.g., wound) to form a cord 42 (FIG. 3C). Thus, the tension member 36 may be regarded as a wire 38, strand 40, cord 42, or any combination thereof.

FIG. 4 illustrates the tension member 36 and a protective coating 44 that extends around the perimeter and length of the tension member 36. In this regard, depending on the design of the tension member 36 as described above, the protective coating 44 may be on a wire 38 as in FIG. 3A, strand 40 as in FIG. 3B, or cord 42 as in FIG. 3C. In the case of a strand 40 or a cord 42, the protective coating 44 may be applied to the outside surfaces of the strand 40 or cord 42, or alternatively to the individual wires 38 prior to formation into the strands 40 and cords 42.

The protective coating 44 includes a first corrosion inhibiter, a second corrosion inhibiter, and a third corrosion inhibiter that serve different protection mechanisms with regard to corrosion resistance. The first corrosion inhibiter is an oxide-forming metal, such as a transition metal, that provides an oxide film on the tension member 36 and also repairs any disparities in the oxide film to thereby inhibit corrosion of the tension member 36. The second corrosion inhibiter serves as cathodic inhibiter that reduces corrosion rates by decreasing the cathodic reaction rate. Finally, the third corrosion inhibiter adsorbs onto the metal surface of the tension member 36 and prevents anion adsorption, which may otherwise result in corrosion of the tension member 36. The organic material is also hydrophobic and thereby repels water to further increase corrosion resistance. Thus, the protective coating 44 provides a hybrid effect among three different types of corrosion inhibiters that each serve a different purpose with regard to corrosion protection.

The first corrosion inhibiter is selected from oxide-forming metals and combinations thereof. The second corrosion inhibiter is selected from rare earth metals and combinations thereof, and the third corrosion inhibiter is selected from organic materials and combinations thereof. In some examples, the oxide-forming metal is chromium (III), molybdenum, tungsten, or combinations thereof. In other examples, the oxide-forming metal is iron, zinc, aluminum, copper or combinations thereof. The first corrosion inhibiter may include iron, zinc, aluminum, and/or copper in place of or in addition to chromium (III), molybdenum, tungsten.

The rare earth metal of the second corrosion inhibiter may be selected from cesium, lanthanum, yttrium, and combinations thereof. The rare earth metals may be used alone or in combination, depending upon the desired degree of corrosion resistance, for example. One or more of the rare earth metals may be used in combination with one or more of the metals of the first corrosion inhibiter.

The third corrosion inhibiter may include an organic material selected from benzoates, phthalates, acetates, salicylates, succinates, carboxylates, and combinations thereof. The organic materials may be used alone or in combination, and may be used in combinations with one or more metals of the first corrosion inhibiter and one or more rare earth metals of the second corrosion inhibiter. In a further example, the protective coating 44 includes only the first corrosion inhibitor, the second corrosion inhibitor, and the third corrosion inhibitor, as described in the above examples.

FIG. 5 illustrates a modified embodiment in which an additional protective coating 46 is disposed on the protective coating 44. For example, the protective coating 46 may be a zinc coating that provides the tension member 36 with additional corrosion resistance. As an example, the zinc coating serves as a sacrificial layer for enhancing corrosion resistance.

The protective coating 44 may be deposited onto the tension member 36 in a treatment process. The treatment process may include dipping, spraying, or otherwise exposing individual wires 38, strands 40, or cords 42 of the tension member 36 to a corrosion inhibiter solution. As an example, the corrosion inhibiter solution may be an aqueous solution that includes salts of the first corrosion inhibiter, the second corrosion inhibiter, and the third corrosion inhibiter.

In one example, the corrosion inhibiter solution includes an oxide-forming metal salt, a rare earth metal salt, and an organic salt. The oxide-forming metal salt, which later reduces to the first corrosion inhibiter, may be an alkali metal salt of iron, zinc, aluminum, copper, chromium, molybdenum, tungsten, or combination thereof, such as M₂MoO₄, M₂WO₄, MCrO₂, where M is the alkali metal. The rare earth metal salt, which reduces to the second corrosion inhibitor, may be CeX₃, LaX₃, YX₃, or combination thereof, where X is a halogen. The organic salt, which reduces to the third corrosion inhibitor, may be an alkali metal salt of a benzoate, phthalate, acetate, salicylate, succinate or combination thereof.

After exposure between the tension member 36 and the corrosion inhibiter solution, the exposed tension member 36 may be dried, such as at room temperature or in an elevated heat environment, to form the protective coating 44 thereon. In this regard, the salts of the oxide-forming metal and rare earth metal deposit in metallic or oxide form, and organic salt deposits as an organic compound.

In some examples, the corrosion inhibiter solution is designed with a composition that is intended to provide the protective coating 44 with a desired composition for corrosion resistance. As an example, the corrosion inhibiter solution includes 1-10 vol. % of the first corrosion inhibiter, 100 parts per million-1 vol. % of the second corrosion inhibiter, 100 parts per million-10,000 parts per million of the third corrosion inhibitor, and a balance of water. Additionally, the concentrations of the inhibitors may be adjusted to control pH to a desired level, such as in the neutral range of about 7.

The tension member 36 may be treated for a time of about 1-5 minutes, however, the time may be varied depending upon the desired thickness of the protective coating 44. Additionally, the surfaces of the tension member 36 may be cleaned prior to treatment to facilitate adhesion between the protective coating 44 and the tension member 36. If the additional protective coating 46 is to be used, the tension member 36 with the protective coating 44 may then be subjected to a conventional zinc coating process to deposit the zinc coating.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A load bearing member, comprising:
at least one elongated tension member comprising at least one wire; and
a protective coating on the elongated tension member, the protective coating including a first corrosion inhibitor selected from a group consisting of oxide-forming metals and combinations thereof, a second corrosion inhibitor selected from a group consisting of rare earth metals and combinations thereof, and a third corrosion inhibitor comprising an organic material.

2. The load bearing member as recited in claim 1, wherein the at least one wire comprises a plurality of wires and the protective coating is applied to each of the plurality of wires.

3. The load bearing member as recited in claim 1, wherein the elongated tension member includes a plurality of wires and at least one strand formed form at least some of the plurality of wires, and the protective coating is applied to the at least one strand.

4. The load bearing member as recited in claim 1, wherein the elongated tension member includes a plurality of wires, and at least one cord formed from at least one strand formed from at least some of the plurality of wires, and the protective coating is applied to the at least one cord.

5. The load bearing member as recited in claim 1, wherein the rare earth metal is selected from a group consisting of cesium, lanthanum, yttrium, and combinations thereof.

6. The load bearing member as recited in claim 1, wherein the organic material is selected from a group consisting of benzoates, phthalates, acetates, salicylates, succinates, carboxylates, and combinations thereof.

7. The load bearing member as recited in claim 1, wherein the rare earth metal is selected from a group consisting of cesium, lanthanum, yttrium, and combinations thereof, and the organic material is selected from a group consisting of benzoates, phthalates, acetates, salicylates, succinates, carboxylates, and combinations thereof.

8. The load bearing member as recited in claim 1, wherein the oxide-forming metal is chromium.

9. The load bearing member as recited in claim 1, wherein the oxide-forming metal is molybdenum.

10. The load bearing member as recited in claim 1, wherein the oxide-forming metal is tungsten.

11. The load bearing member as recited in claim 1, wherein the first corrosion inhibiter is selected from a group consisting of iron, zinc, aluminum, copper, and combinations thereof.

12. The load bearing member as recited in claim 1, wherein the protective coating consists of the first corrosion inhibitor, the second corrosion inhibitor, and the third corrosion inhibitor, wherein the first corrosion inhibitor is selected from a group consisting of chromium, molybdenum, tungsten, and combinations thereof or oxides of chromium, molybdenum, tungsten, and combinations thereof, the second corrosion inhibitor is selected from a group consisting of cesium, lanthanum, yttrium and combinations thereof, and the third corrosion inhibitor is selected from a group consisting of benzoates, phthalates, acetates, salicylates, succinates, carboxylates, and combinations thereof.

13. The load bearing member as recited in claim 1, wherein the at least one elongated tension member comprises steel wires on which the protective coating is disposed.

14. A method for treating a load bearing member, the method comprising:
treating at least one elongated tension member having at least one wire with a corrosion inhibitor solution that includes a first corrosion inhibitor selected from a group consisting of oxide-forming metal salts and combinations thereof, a second corrosion inhibitor selected from a group consisting of rare earth metal salts and combinations thereof, and a third corrosion inhibitor selected from a group consisting of organic salts and combination thereof to produce a multifunctional protective coating on the at least one elongated tension member.

15. The method as recited in claim 14, wherein the at least one wire comprises a plurality of wires, and the treating step includes treating each of the plurality of wires.

16. The method as recited in claim 14, wherein the at least one wire comprises a plurality of wires and at least one strand formed form at least some of the plurality of wires, and the treating step includes treating the at least one strand.

17. The method as recited in claim 14, wherein the at least one wire comprises a plurality of wires, at least one cord formed from at least one strand formed from at least some of the plurality of wires, and the treating step includes treating the at least one cord.

18. The method as recited in claim 14, wherein the oxide-forming metal salt is selected from a group consisting of M₂MoO₄, M₂WO₄, MCrO₂, and combinations thereof, wherein M is an alkali metal.

19. The method as recited in claim 14, wherein the rare earth metal salt is selected from a group consisting of CeX₃, LaX₃, YX₃, and combinations thereof, wherein X is a halogen.

20. The method as recited in claim 14, wherein the organic salt is a metal salt selected from a group consisting of benzoates, phthalates, acetates, salicylates, succinates, carboxylates, and combinations thereof.

21. The method as recited in claim 14, wherein the rare earth metal salt is selected from a group consisting of CeX₃, LaX₃, YX₃, and combinations thereof, wherein X is a halogen and the organic salt is a metal salt selected from a group consisting of benzoates, phthalates, acetates, salicylates, succinates, carboxylates, and combinations thereof.

22. The method as recited in claim 14, wherein the oxide-forming metal salt includes a metal selected from a group consisting of chromium, molybdenum, tungsten, and combinations thereof.

23. The method as recited in claim 14, wherein the oxide-forming metal salt includes a metal selected from a group consisting of iron, zinc, aluminum, copper, and combinations thereof.

24. The method as recited in claim 14, wherein the multifunctional corrosion inhibitor solution includes a concentration of 1-10 vol. % of the first corrosion inhibiter, 100 parts per million-1 vol. % of the second corrosion inhibiter, and 100 parts per million-10,000 parts per million of the third corrosion inhibiter, and a balance of water.
